(19) United States
(12) Patent Application Publication
(10) Pub. No.: US 2019/0063699 A1
(43) Pub. Date: Feb. 28, 2019

(54) THREE-DIMENSIONAL LIGHTED OBJECT DISPLAY DEVICE

(71) Applicant: Exotic Christmas LLC, Mandeville, LA (US)

(72) Inventor: Jeffery Lacour, Mandeville, LA (US)

(73) Assignee: Exotic Christmas LLC, Mandeville, LA (US)

(21) Appl. No.: 15/687,468

(22) Filed: Aug. 26, 2017

(51) Int. Cl. F21S 4/26; F21V 33/00; E04H 12/32; F16M 11/22

(52) U.S. Cl. CPC F21S 4/26; F16M 11/22; E04H 12/32; F21V 33/0028

(57) ABSTRACT

A three-dimensional display device is provided with at least three elongated support legs. The legs are oriented and peripherally spaced around a central vertical axis forming an open leg cavity between the support legs, allowing for unobstructed passage of light through the cavity. The outer surface of each of the support legs defines a plurality of notches spaced longitudinally along the outer surface of each support leg, and the notches are adapted to receive and to secure against movement relative to the leg a portion of an elongated flexible light emitting tubular member, forming a three-dimensional helical patterned illumination.

### BACKGROUND OF THE INVENTION

### Field of the Invention

The present invention relates generally to a three-dimensional display device. More specifically, the present invention relates to a three-dimensional lighted display device that is easy to assemble and can be illuminated with flexible tubular lights.

### Description of the Related Art

Throughout history, humans have sought to enhance their surroundings by the use of decorative items. Such items have included diverse elements such as wall paintings, tiles, tapestries and two-dimensional art, to name a few. In many instances, such decorative elements become a relatively permanent part of the environment in which they are placed, remaining on display for years on end. In contrast to these long-term decorations, some decorative items are intended to be of a more transient nature. One example is the use of fresh cut flowers that have a display life of only a few days.

Decorative displays and lighting are known for use at both homes and businesses to achieve a desired architectural or visual effect. Decorative light strings are one type of well known decorative system that is particularly popular for use around the fall and wintertime holidays. Many individuals believe that there is nothing like a cheerful string of lights to foster the holiday spirit. Bright, twinkling, or flashing lights and decorative ornamental displays are a few of the joys and traditions of the holiday season. When displayed at a home, building, or other structure, lighting systems and ornamental displays are known for providing a holiday visual effect akin to a decorated gingerbread house, and therefore are desirable to traditionalist holiday decorators. Other alternatives, such as rope lights, are commonly known and used in the art. Rope lights contain the light emitting components within a flexible conduit or “rope” sheath providing for partially snag-free installation and removal conventionally utilizing numerous clips and multiples of fasteners.

In recent years there has been an increase in the use of lights, lighting and various displays for decorating on various special occasions and holidays including but not limited to promotional events, sporting events, Christmas, Thanksgiving, Easter, Valentine's Day, Fourth of July, Halloween, New Year's Eve, St. Patrick's Day, Memorial Day, Labor Day, advent of spring, fall harvest, the birth of a child, an anniversary, a birthday, and the like. Sporting events and Christmas bring out a large amount of decorations both inside and outside of various homes, offices, office buildings, restaurants, businesses, parks, malls, and the like.

Modern decorations are also replete with flat, two-dimensional, color printed and painted placard-type forms which are hung or erected in the yard by means of a stake or prop attached to the form. These forms are typically made from wood, plastic, cardboard, corrugated materials, and the like. More expensive versions may comprise molded plastic with openings formed therein to hold lights. These type forms are provided with a light inside the form, or forms without lights may be illuminated at night with separate flood or spot lights directed at the exterior of the form. Such decorations may provide depictions of characters, objects, text, and/or other subject matter. Such portrayals may include Santa and his reindeer, snowmen, scarecrows, and the like. Common non-holiday decorative displays may include but are not limited to various animal depictions such as those often seen placed about a garden setting or landscaping bed.

Over the years, various devices have been made to assist people with illuminating decorative items to achieve a desired architectural or visual effect. However, such commonly known devices are of complex construction, largely inefficient in operation, and often result in limited display of illuminated decorative elements. There is a need for a three-dimensional device for users' to easily and efficiently display the desired illuminated effects,

U.S. Pat. No. 5,379,202 issued to Daun relates to an animated light display formed of a rigid wire frame covered with a plurality of light string sets. The light display includes a sculpted frame. However, because the frame only two-dimensionally outlines the character and has a relatively thin diameter, comfortable angles of view are limited making features of the display difficult to discern. Moreover, a plurality of mounting clips constituted of spring steel are successively positioned along and clipped onto the wires and over the wire frame, complicating construction, assembly, and reconfiguration of illumination.

U.S. Pat. No. 5,577,831 issued to Chang relates to a decorative toy in the form of a rabbit. A frame of the toy is rabbit-shaped and has an upper transparent cover mounted thereon. The circumference of the frame is provided with a groove having a plurality of partitions and is filled with a translucent gem having a refractive property so as to form a translucent region around the circumference of the frame. A plurality of light-emitting diodes (LEDs) illuminate the translucent region so as to give the appearance of a neon lamp. However, the frame is also provided with a bottom cover that will prevent ambient light from effectively shining through when the toy is unlit.

A conventional decorative apparatus is a wire form provided in U.S. Pat. No. 5,955,156 issued to Hermanson, which discloses a lighted display device having a sculpted frame formed of thin wire or tubing. The wire outlines translucent panels at selected areas of the figure to slightly allow at least some ambient light to transmit through it during the daytime. Such devices are complex in construction and inconvenient in assembly and use. All of the aforementioned patents are incorporated herein by reference.

While these units may be suitable for the particular purpose employed, they would not be as suitable for the purposes of the present invention as disclosed hereafter.

Accordingly, there is a need for a three-dimensional lighted object display device for users' to easily and efficiently display the desired illuminated effects in a more convenient, visually effective and efficient manner.

As disclosed in this application, the inventor has discovered novel and unique devices and methods for efficient and visually effective display of illuminations, which exhibit superlative properties without being dependent on numerous, expensive or complex components.

Embodiments of the present invention provide for devices and methods as disclosed herein and as defined in the annexed claims which provide for improved structural and illuminative features in order to efficiently support and display illuminative devices and effects in a variety of configurations, for people's desired decorations.

Embodiments of the present invention provide for three-dimensional display structures and features as defined in the annexed claims which provide for improved mobility, set up, and anchoring characteristics in order to efficiently support and display the illuminated tubular devices and position the stands of various configurations to many surfaces of interest in a multitude of environments.

### SUMMARY OF THE INVENTION

It is one prospect of the present invention to provide one or more novel three-dimensional display devices of simple but effective construction which can be applied to many environments to efficiently and effectively support and display illuminating devices and effects in a variety of configurations for people's desired decorations. Another object of the present invention to provide a three-dimensional display device which may be easily assembled.

It is yet another object of the present invention to provide a three-dimensional display device that is attractive and eye-catching when assembled. It is a further object of the invention to provide a three-dimensional display device which may be attractively illuminated, while conveniently providing structural support to one or more devices providing the illumination. It is yet another object to provide easy access to adjust, replace, or repair one or more illuminating devices upon the display.

It is a further object of the invention to provide a three-dimensional display device which may be easily reconfigured and which may provide a three-dimensional double-helix illumination.

It is yet another object of the present invention to provide a three-dimensional display device which may be easily and compactly stored when not in use. It is a further object of the present invention to provide a three-dimensional display device that is relatively lightweight and sturdy.

The following presents a simplified summary of the present disclosure in a simplified form as a prelude to the more detailed description that is presented herein.

Therefore, in accordance with embodiments of the invention, there is provided a three-dimensional lighted object display device for illuminating and displaying a desired decorative or visual effect. In one embodiment, the device has at least three elongated support legs, and each support leg has an upper portion opposite a lower portion. In such embodiment, the support legs are oriented relative to each other so as to have an outer surface radially disposed opposite an inner surface. The outer surface of each support leg preferably defines a plurality of tubular member support notches. In a preferred embodiment, the plurality of notches are spaced longitudinally along the outer surface of each support leg and are adapted to receive and to secure against movement relative to the leg a portion of an elongated flexible light emitting tubular member. The elongated support legs form a visually unobstructed three-dimensional cavity between the legs. The device preferably comprises a base assembly rigidly connected to the lower portion of at least two of said support legs.

In a preferred embodiment, the three-dimensional lighted object display device has four elongated support legs. Preferably, the base assembly is characterized as bell-shaped comprising at least four arcuate base leg members, and each base leg member has an outer surface defining a plurality of tubular member support notches adapted to receive and secure against movement relative to said base leg a portion of an elongated flexible light emitting tubular member.

In another embodiment, the device also has an elongated flexible light emitting tubular member wherein the elongated flexible light emitting tubular member is spirally mounted to the support legs as securely engaged with the notches.

In yet another embodiment, the three-dimensional lighted object display device has a first elongated flexible light emitting tubular member and a second flexible light emitting tubular member, wherein the first and second tubular members preferably encircle the support legs as securely engaged with the notches to provide unobstructed illumination around the device.

In another embodiment, the notches of the three-dimensional lighted object display device are characterized as being smaller in size than the diameter of the flexible light emitting tubular member that is to be received and supported without fasteners, such that an illumination from the light emitting tubular member would remain unobstructed when the tubular member is received and supported by the notches of the support legs.

In yet another embodiment, the notches along the outer surfaces of the support legs are pre-configured for receipt of respective portions of the elongated flexible light emitting tubular member to provide a visual display of illumination correlating to said pre-configuration of notches.

In yet another embodiment, the three-dimensional lighted object display device further comprises a three-dimensional head assembly having at least three head support members that are peripherally spaced around a central axis of the head assembly, which provides a head cavity between the head support members. In such embodiment, each head support member has an outer surface defining a plurality of notches that are adapted to receive and support an elongated flexible light emitting tubular member, and the head assembly preferably outlines a character or an object.

In one embodiment, the plurality of notches provide a radial separation between elongated flexible light emitting tubular members that encircle the support legs when the tubular members are received by the notches. Such radial separation of the encircling or swirling light emitting tubular members forms an open light cavity within the encircling tubular members, providing for three-dimensional illuminated display.

In one embodiment, the plurality of notches of the three-dimensional lighted object display device are disposed in a repetitive helical pattern relative to the elongated support legs.

The three-dimensional lighted object device is preferably of unitary construction, such that the body is a single piece of a homogenous material, forged from a material selected from a group consisting of plastic, resin, high-density polyethylene, rubber, and steel.

In another preferred embodiment, a lighted device is provided comprising a vertical support structure having at least three vertical support leg members, and each vertical support leg member is peripherally spaced around a central vertical axis of the vertical support structure thereby forming an open leg cavity between the vertical support legs, allowing for unobstructed passage of light through the cavity. Each vertical support leg preferably has an outer surface defining a plurality of axially spaced notches which are preferably oriented transverse to the support leg and are adapted to receive and support an elongated flexible light emitting tubular member. The flexible tubular member is preferably cylindrical in shape, meaning it preferably has a circular cross-section when unflexed.

Preferably, each vertical support leg member has an upper section transitioning to a connection point where it joins preferably all of the other vertical support leg members, and it preferably has a lower section transitioning to a base portion of the device that is configured to balance the vertical support structure in a substantially upright free-standing position.

A head portion is preferably disposed atop the connection point of the upper section of the vertical support members, and the head portion preferably has at least three head support members peripherally spaced around a central axis of the head portion to provide a head cavity between the head support members. Each head support member has an outer surface preferably defining a plurality of support notches adapted to receive and support an elongated flexible light emitting tubular member, providing resistance against axial and radially inwardly movement of the tubular member relative to the head support member at each notch.

Preferably, the lighted device has at least a first elongated flexible light emitting tubular member disposed around the vertical support structure and head portion of the device, which tubular member is structurally supported by and fitted within the notches to provide structurally unobstructed illuminating effect by the light emitting tubular member around the outer periphery of the device and through the cavities of the device.

In one embodiment, the lighted device further comprises a second elongated flexible light emitting tubular member disposed around the vertical support structure and head portion, and such second tubular member is supported by and fitted within the notches, wherein the notches are configured to orient a plurality of flexible light emitting tubular members in at least a double helix orientation, to provide double helix illuminating effect along the outer periphery of and through the cavities of said device.

In one embodiment, the head portion is characterized as outlining a three-dimensional object forming a sphere. In another embodiment, the head portion is characterized as outlining a three-dimensional object forming a flame.

In yet another preferred embodiment, a helical light display is provided comprising a rigid rod frame having an ornamental configuration, and the frame defines a plurality of notches disposed along an outer surface of the rod frame. In such embodiment, the notches are preferably adapted to receive and support an elongated flexible light emitting tubular member, wherein the notches are configured to orient a plurality of flexible light emitting tubular members in at least a double helix orientation.

The helical light display preferably comprises a first elongated flexible light emitting tubular member helically disposed around the rigid rod frame as supported by and fitted within the notches, and a second elongated flexible light emitting tubular member helically disposed around the rigid rod frame in between the first helically disposed elongated light emitting member.

The helical light display preferably comprises a single electrical supply wire splitting and transitioning to a first elongated flexible light emitting tubular member having a first color helically disposed around said rigid rod frame as supported by and fitted within the notches, and a second elongated flexible light emitting tubular member having a second color helically disposed around the rigid rod frame in between the first helically disposed elongated light emitting member.

In a preferred embodiment, the helical light display comprises a plurality of elongated flexible light emitting tubular members helically disposed around the rigid rod frame as fitted within and supported by the notches forming a double helix orientation of the tubular members.

In yet another preferred embodiment, the helical light display comprises a plurality of elongated flexible light emitting tubular members helically disposed around the rigid rod frame as fitted within and supported by the notches forming a triple helix orientation of the tubular members.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a front perspective view of an exemplary three-dimensional lighted object display device in accordance with embodiments of the invention;

FIG. 2 is a front left perspective view thereof;

FIG. 3 is another front further left perspective view thereof;

FIG. 4 is an exploded view of embodiments illustrated in FIG. 2;

FIG. 5 is a front left perspective view of an exemplary three-dimensional lighted object display device in accordance with an embodiment of the invention;

FIG. 6 is front further left perspective view of embodiments illustrated in FIG. 5;

FIG. 7 is a top view of embodiments of the invention;

FIG. 8 is a front perspective view of an exemplary lighted device in accordance with embodiments of the invention;

FIG. 9 is a close-up front left perspective view thereof in accordance with embodiments of the invention;

FIG. 10 is a front left perspective view thereof in accordance with embodiments of the invention;

FIG. 11 is a front further left perspective view thereof in accordance with embodiments of the invention;

FIG. 12 is a close-up front elevation view in accordance with embodiments of the invention;

FIG. 13 is a close-up front elevation view in accordance with other embodiments of the invention; in accordance with embodiments of the invention;

FIG. 15 is a close-up front elevation view in accordance with embodiments of the invention;

FIG. 16 is a bottom view of embodiments of the invention;

FIG. 17A is a close-up front left elevation view in accordance with embodiments of the invention;

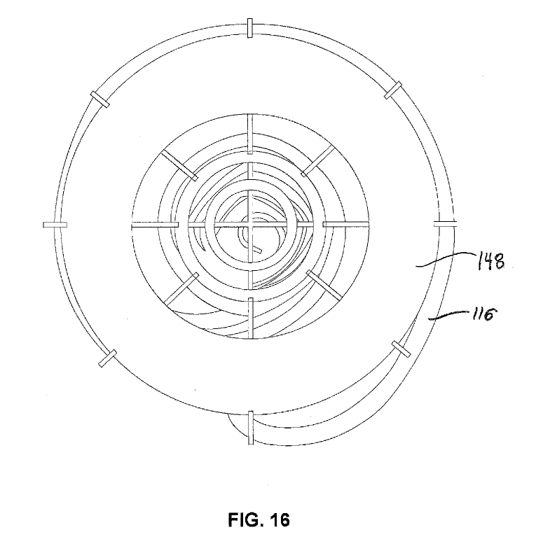

FIG. 17B is a close-up front left elevation view of embodiments illustrated in FIG. 15; and

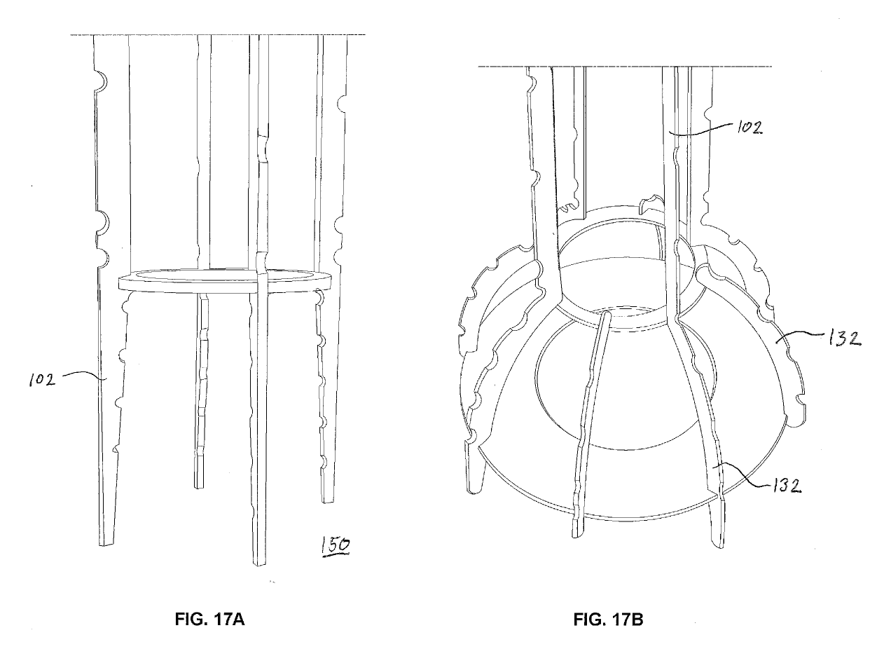

FIG. 18 is a front perspective view of an exemplary lighted device in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” or “longitudinal axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

In accordance with embodiments of the invention, there is provided a three-dimensional lighted object display device for illuminating and displaying a desired decorative or visual effect.

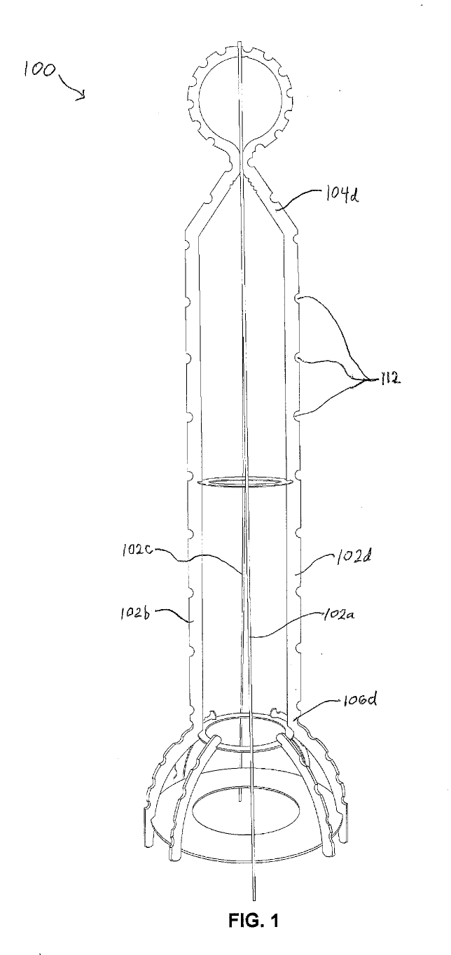

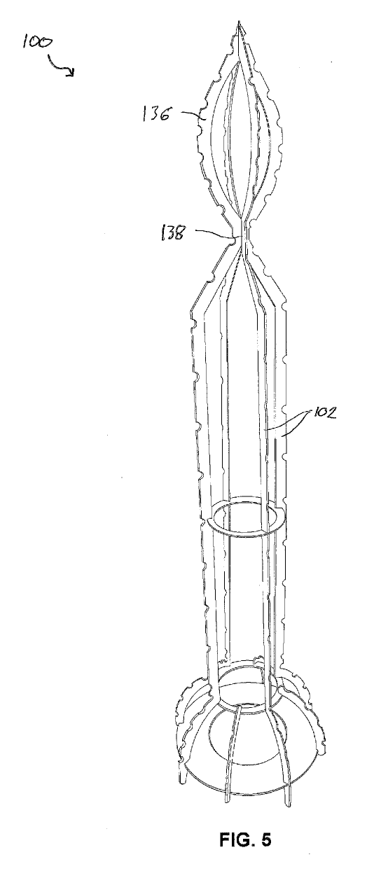

Referring initially to FIGS. 1-7, the basic constructional details and principles of operation of embodiments of a three-dimensional lighted object display device 100 according to preferred embodiments of the present invention will be discussed.

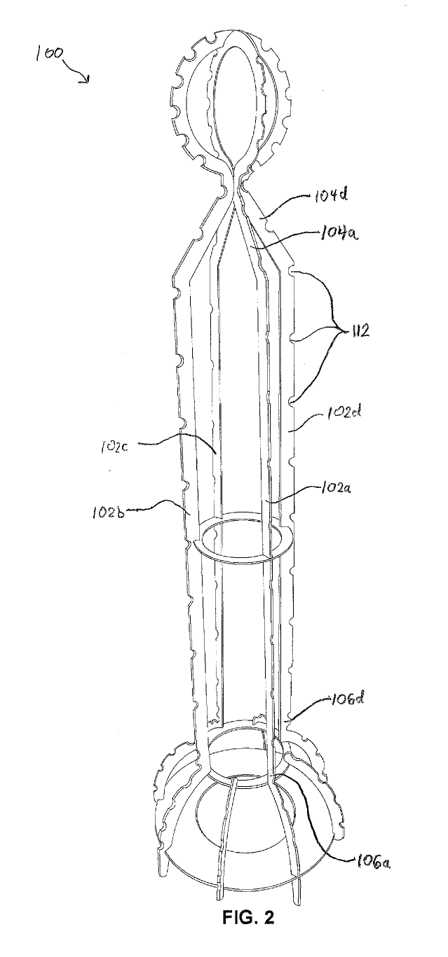

A lighted object display device 100 according to a preferred embodiment of the present invention is provided. As illustrated in FIGS. 1-7, the device 100 comprises at least three elongated support legs 102, and in a preferred embodiment, the device 100 preferably comprises four elongated support legs 102a, 102b, 102c, 102d. As seen in FIGS. 2, 4 and 5, there are four elongated leg members 102a, 102b, 102c, 102d depicted in these preferred embodiments. Each support leg 102 is preferably a fabricated as a flat steel bar member, as illustrated in the FIG. 1. Alternatively, one or more support legs 102 may be fabricated as a round steel rod member.

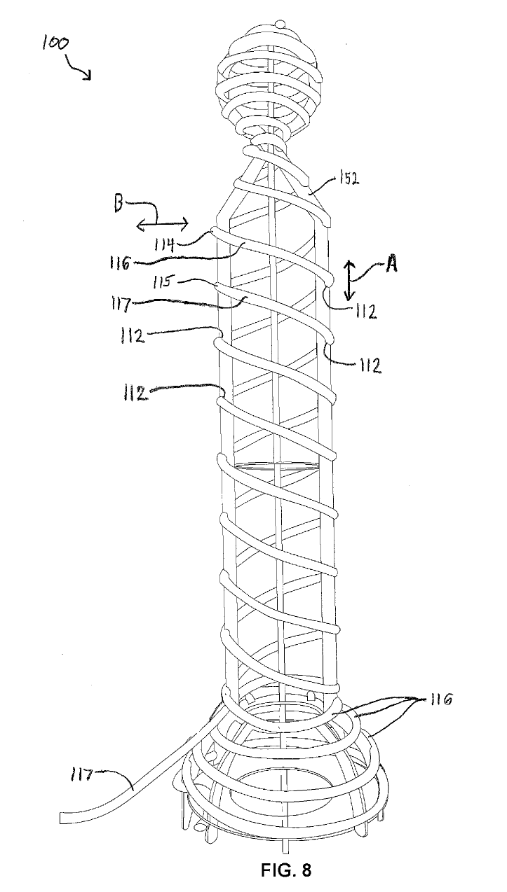

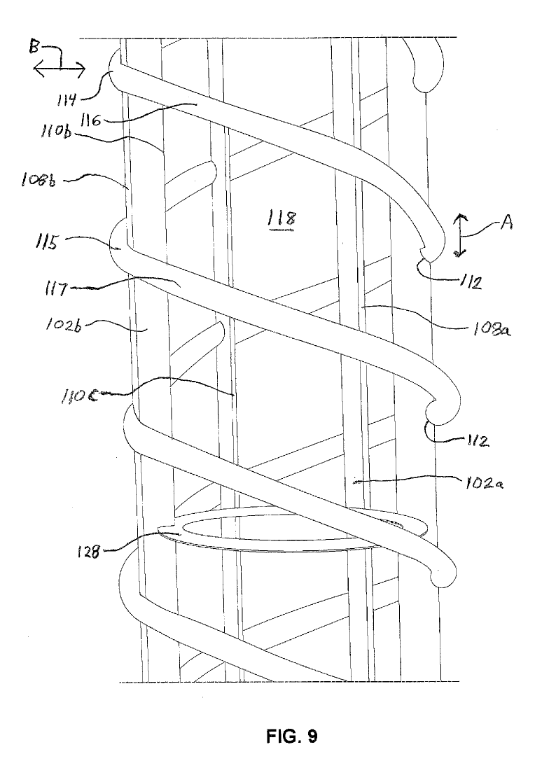

Each support leg 102 preferably has an upper portion 104 (e.g., 104a, 104d) opposite a lower portion 106 (e.g., 106a, 106d). In such embodiments, the support legs 102a, 102b, 102c, 102d are oriented relative to each other so as to have an outer surface 108 radially disposed opposite an inner surface 110, as illustrated in FIG. 9 at, e.g., 108b and 110b of leg 102b. The outer surface 108 of each support leg 102 preferably defines a plurality of tubular member support notches 112. In a preferred embodiment, the plurality of notches 112 are spaced longitudinally along the outer surface 108 of each support leg 102 and are adapted to receive and to secure against movement (e.g., exemplary movement arrows A and B in FIGS. 8-9) relative to the leg 102 a respective portion 114, 115 of an elongated flexible light emitting tubular member 116, 117, such as a rope light. As illustrated in FIGS. 8-9, the notches 112 are configured to receive and securely maintain portions 114, 115 of one or more respective flexible light emitting tubular members 116, 117. In such manner, embodiments of the invention provide for snag-free installation and removal of elongated flexible light emitting tubular members 116, 117, without requiring numerous clips and multiples of fasteners.

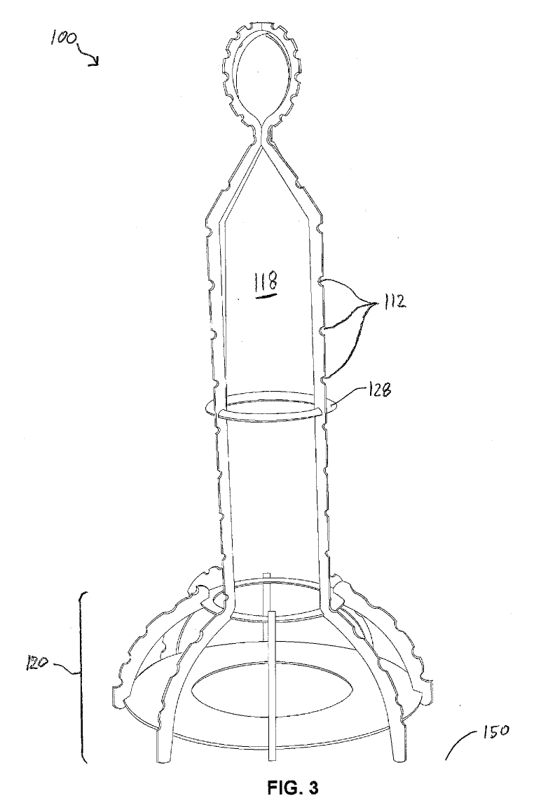

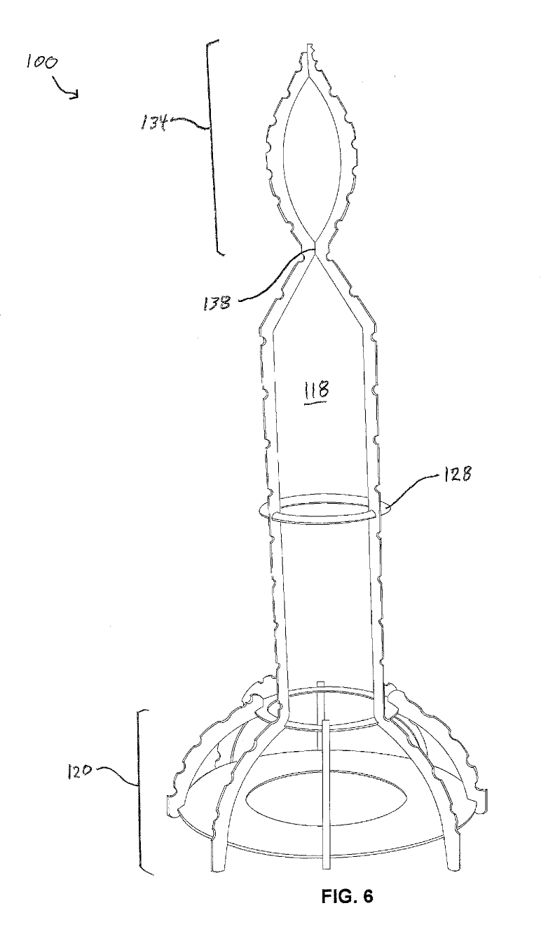

The elongated support legs 102 form a visually unobstructed three-dimensional cavity 118 between the legs 102, as illustrated in FIG. 3 and FIG. 6. The device 100 preferably comprises a base assembly 120 rigidly connected to the lower portion 106 of at least two of said support legs 102. In one preferred embodiment, a ring member 128 is rigidly connected to the inner surface 110 of each leg member 102, to provide additional structural stability and rigidity to the device 100.

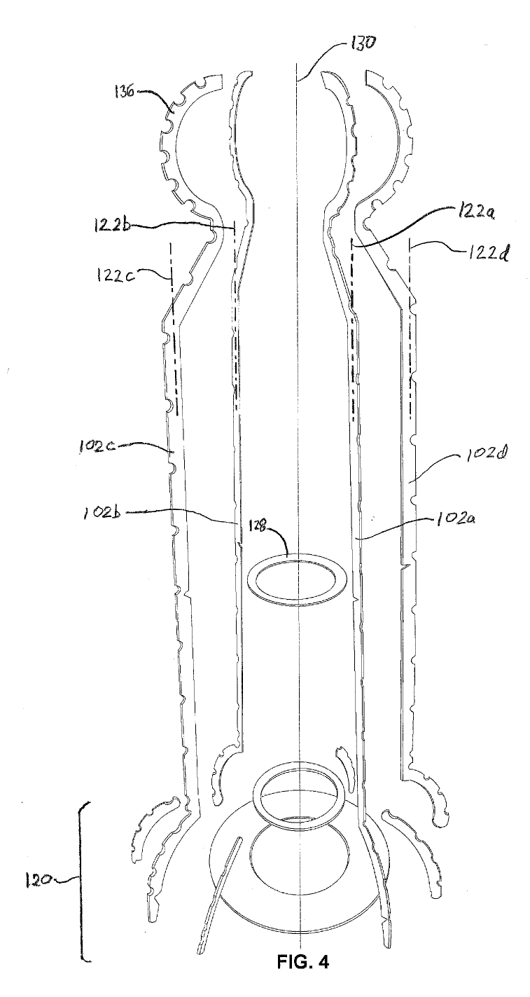

In a preferred embodiment, the three-dimensional lighted object display device 100 has four elongated support legs 102a, 102b, 102c, 102d, as shown in FIG. 2 and illustrated in the exploded view in FIG. 4. Each support leg 102 has a respective central longitudinal axis 122a, 122b, 122c, 122d that is preferably parallel to the axis 122a, 122b, 122c, 122d of the other support legs 102. In other words, axis 102a, axis 102b, axis 102c, and axis 102d are preferably parallel. In a preferred embodiment, axis 102a, axis 102b, axis 102c, and axis 102d are each a vertical axis, each being oriented perpendicular to the ground. In other embodiments, the axis 102a, axis 102b, axis 102c, and axis 102d of the support legs 102 may be oriented parallel relative to each other, while the support legs 102 are positioned diagonally with respect to the ground.

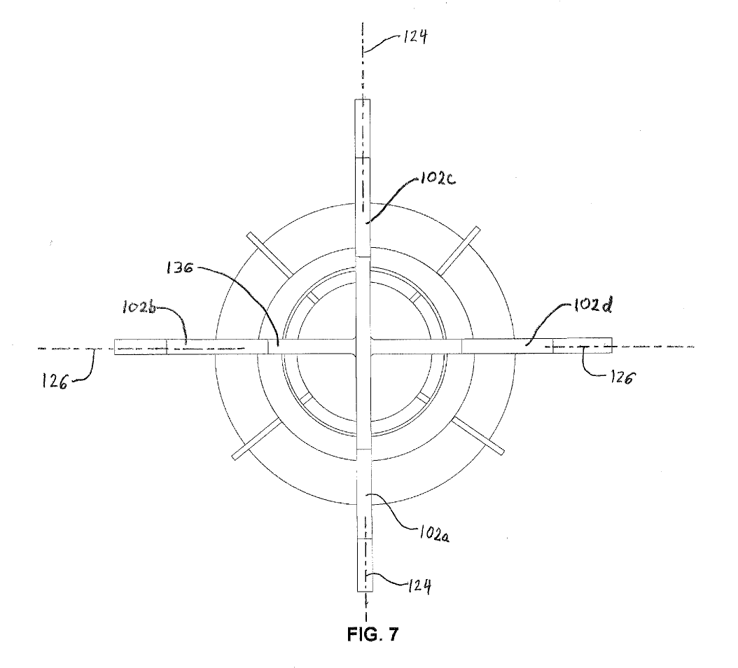

As illustrated in FIG. 7, support legs 102a and 102c are preferably oriented along the same plane 124, and legs 102b and 102d are preferably oriented along the same plane 126. In a preferred embodiment, plane 124 is perpendicular to plane 126, as seen in FIG. 7.

Referring to FIG. 7, in a preferred embodiment, the device 100 comprises at least one elongated flexible light emitting tubular member 116. FIG. 9 illustrates a close up partial view of a spirally engaged elongated flexible light emitting tubular member 116.

The tubular member preferably includes a translucent tubular shell with opposed tube ends having a plurality of lighting elements, such as lightbulbs or light emitting diodes, disposed within the tubular shell. The elongated flexible light emitting tubular member 116 is preferably spirally mounted to the support legs 102 of the device 100 by secure engagement with the notches 112, to provide a spiral illumination around the legs 102 when the tubular member 116 is received within the notches 112 of the device 100.

In yet another embodiment, the three-dimensional lighted object display device 100 has a first elongated flexible light emitting tubular member 116a and a second flexible light emitting tubular member 116b, wherein the first and second tubular members preferably encircle the support legs as securely engaged with the notches 112 to provide unobstructed illumination around the device 100.

In another embodiment, the notches 112 of the three-dimensional lighted object display device 100 are characterized as being smaller in size than the diameter of the flexible light emitting tubular member 116 that is to be received by the device 100 and supported without fasteners, such that an illumination from the light emitting tubular member 116 would remain unobstructed around the device 100 when the tubular member is received and supported by the notches 112 of the support legs 102 of the device 100.

To be held in position without fasteners or absent fasteners means that the typical multitude of conventional clips, rivets, and wire ties are not required for the tubular member to be secured to the device 100 because of the structural configuration of the support legs 102 and notches 112.

In other words, in one embodiment, a three-dimensional object is provided having a plurality of support legs 102 having externally notched walls to receive and support the tubular light. The notches 112 of which are smaller in size than a diameter (transverse cross-section) of the tubular light to be received and supported, whereby the tubular light displayed is unobstructed as received and supported by the object.

In yet another embodiment, the notches 112 along the outer surfaces of the support legs are pre-configured for receipt of respective portions of the elongated flexible light emitting tubular member to provide a visual display of illumination correlating to said pre-configuration of notches 112.

In yet another embodiment, the three-dimensional lighted object display device 100 further comprises a three-dimensional head 134 assembly having at least three head support members 136 that are peripherally spaced around a central axis 131 of the head assembly, which provides a head cavity between the head support members. In such embodiment, each head support member 136 has an outer surface 137 defining a plurality of spaced notches 112 that are adapted to receive and support an elongated flexible light emitting tubular member, and the head assembly 134 preferably outlines a three-dimensional character or an object. In one embodiment, axis 130 is collinear with axis 131. In other embodiments, axis 130 is not collinear with axis 131. In other words, 131 may be configured on a diagonal relative to 130, in embodiments of the invention.

Through embodiments disclosed herein, the plurality of notches 112 provide radial separation between elongated flexible light emitting tubular members 116, 117 that encircle the support legs 102 when the tubular members 116, 117 are received by the notches 112. Such radial separation of the spiraling light emitting tubular members 116, 117 forms an open light cavity 118 within the encircling tubular members, providing for three-dimensional illuminated displays.

Elongated legs define a plurality of notches 112 disposed along an outer wall of each elongated leg, said plurality of notches 112 providing a radial separation between spiraling/encircling tubular members 116, 117 upon receipt of said tubular members 116, 117 in said notches 112 creating an open cavity within said spiral for three-dimensional illuminated display.

In one embodiment, the plurality of notches 112 of the three-dimensional lighted object display device 100 are disposed in a repetitive helical pattern relative to the elongated support legs 102.

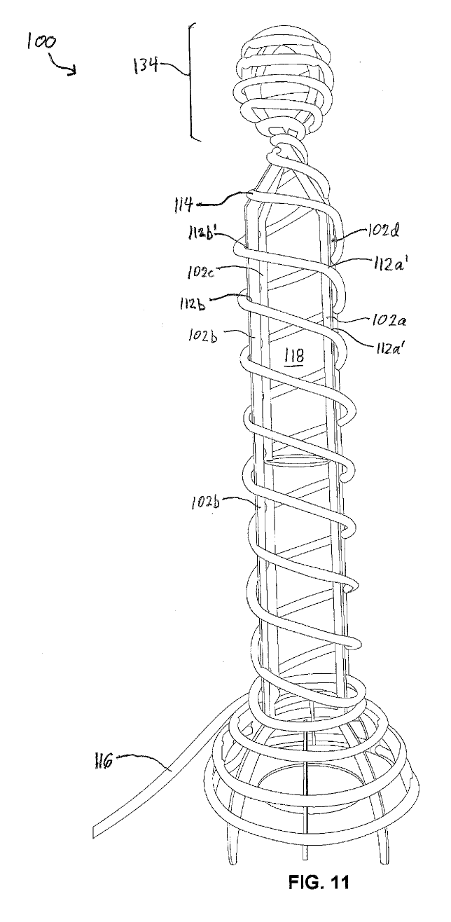

As seen in FIG. 11, there are four elongated leg members 102a, 102b, 102c, 102d depicted in such exemplary embodiment. In a preferred embodiment, exemplary notch 112b of leg 102b is disposed higher, relative to the base assembly, than notch 112a of leg 102a. Similarly, exemplary notch 112b′ of leg 102b is disposed higher, relative to the base assembly, than notch 112a′ of leg 102a. In this manner, a first elongated flexible light emitting tubular member 116, may be connected to the legs through notches 112 of the legs thereby forming a spiral around the legs, and a second elongated flexible light emitting tubular member 117 may be connected to the notches 112 of the leg members 102 thereby forming a second spiral around the legs members 102, wherein the first spiral intertwines with the second spiral and forms a double helix formation around the leg members 102, as illustrated in FIG. 11.

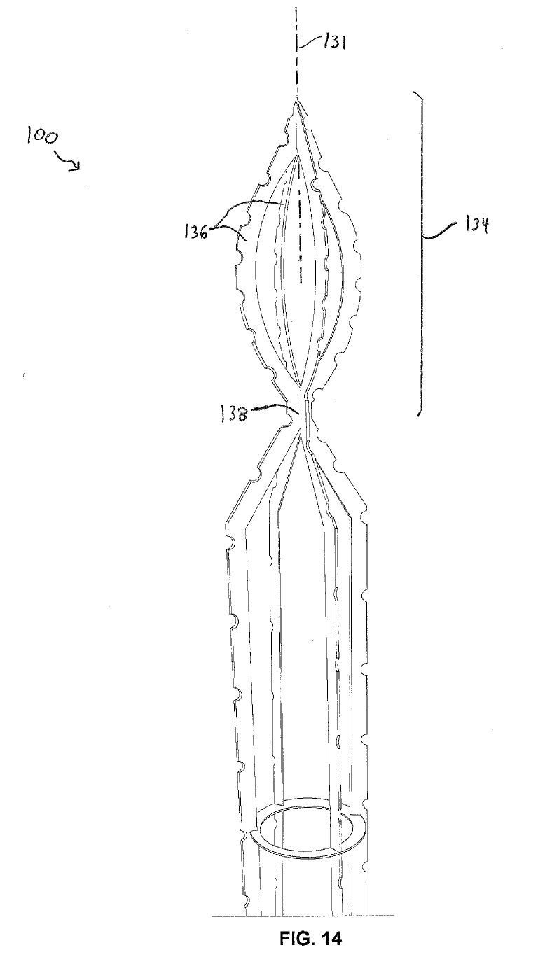

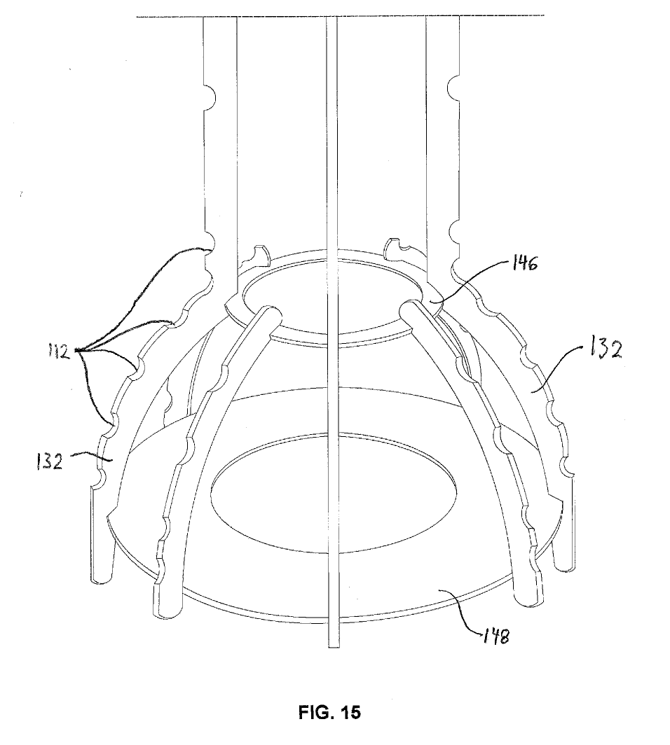

As seen in FIGS. 15-16, in one preferred embodiment, the base 120 comprises a top base ring 146 is rigidly connected to the inner surface of each base leg member 132, and further comprises a base plate ring 148 rigidly connected to the inner surface of each base leg member 132, to provide additional structural stability and rigidity to the base assembly 120 of the device 100.

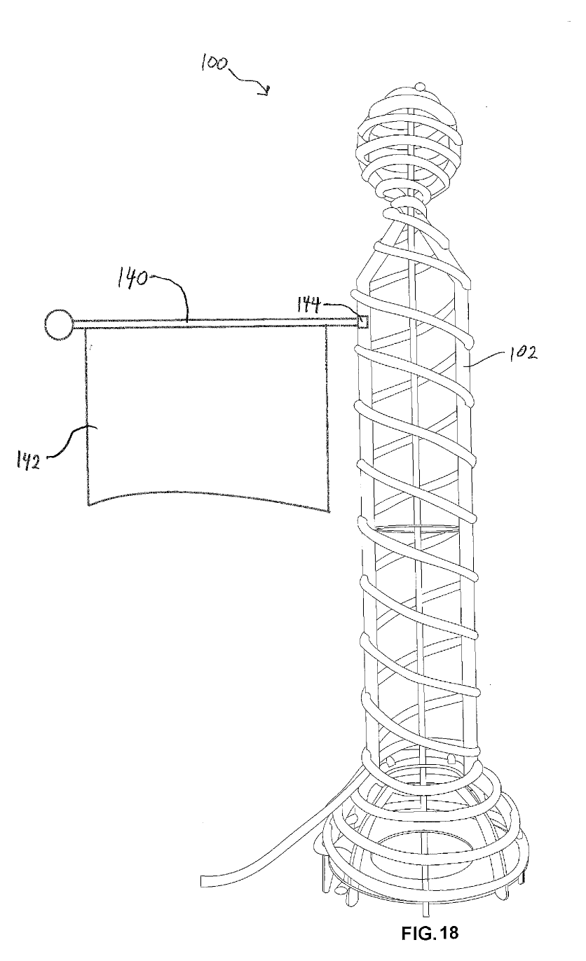

The three-dimensional lighted object device 100 is preferably of unitary construction, such that the body is a single piece of a homogenous material, wherein the legs 102 are forged from a material selected from a group consisting of plastic, resin, high-density polyethylene, rubber, and steel. Alternatively, components of the three-dimensional lighted object device 100 may be welded together, or glued together, to form a rigid structure. In one embodiment, a flag arm 140 is connected to a vertical support arm 102 by preferably threaded connection to an internally threaded coupling nut 144 which is preferably welded to the vertical support arm 102, as illustrated in FIG. 18, to hang a flag 142.

In another preferred embodiment, a lighted device 100 is provided comprising a vertical support structure having at least three vertical support leg members 102, and each vertical support leg member 102 is peripherally spaced around a central vertical axis 130 of the vertical support structure thereby forming an open leg cavity between the vertical support legs, allowing for unobstructed passage of light through the cavity. Each vertical support leg 102 preferably has an outer surface 108 defining a plurality of axially spaced notches 112 which are preferably oriented transverse to the longitudinal axis 122 of the support leg 102 and are adapted to receive and support an elongated flexible light emitting tubular member. The flexible tubular member 116, 117 is preferably cylindrical in shape, meaning it preferably has a circular cross-section when unflexed.

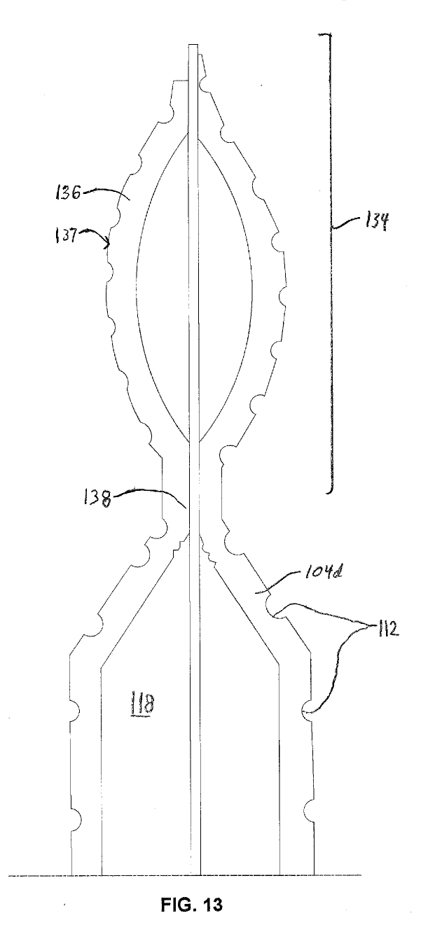

Preferably, each vertical support leg member has an upper section transitioning to a preferably single connection point where it joins preferably all of the other vertical support leg members. The connection point defines a top of the cavity as see in FIG. 13, and it preferably has a lower section transitioning to a base portion of the device 100. The base portion or base assembly 120 is configured to balance the vertical support structure in a substantially upright free-standing position. In one embodiment, at least two vertical members have a lower section transitioning to a base portion.

A head portion 134 is preferably disposed atop the connection point of the upper section of the vertical support members, and the head portion preferably has at least three head support members peripherally spaced around a central axis of the head portion to provide a head cavity between the head support members. Each head support member 136 has an outer surface preferably defining a plurality of support notches 112 adapted to receive and support an elongated flexible light emitting tubular member, providing resistance against axial and radially inwardly and outwardly movement of the tubular member relative to the head support member at each notch.

Preferably, the lighted device 100 has at least a first elongated flexible light emitting tubular member 116 disposed around the vertical support structure and head portion 134 of the device 100, which tubular member 116 is structurally supported by and fitted within the notches 112 to provide structurally unobstructed illuminating effect by the light emitting tubular member around the outer periphery (i.e., 360 degrees) of the device 100 and through the cavities of the device 100. (i.e., unobstructed by support members).

In one embodiment, the lighted device 100 further comprises a second elongated flexible light emitting tubular member 117 disposed around the vertical support structure and head portion 134, and such second tubular member 117 is supported by (without clips) and fitted within the notches 112, wherein the notches 112 are configured to orient a plurality of flexible light emitting tubular members 116, 117 in at least a double helix orientation, to provide double helix illuminating effect along the outer periphery (i.e., 360 degrees) of and through the cavities of said device 100.

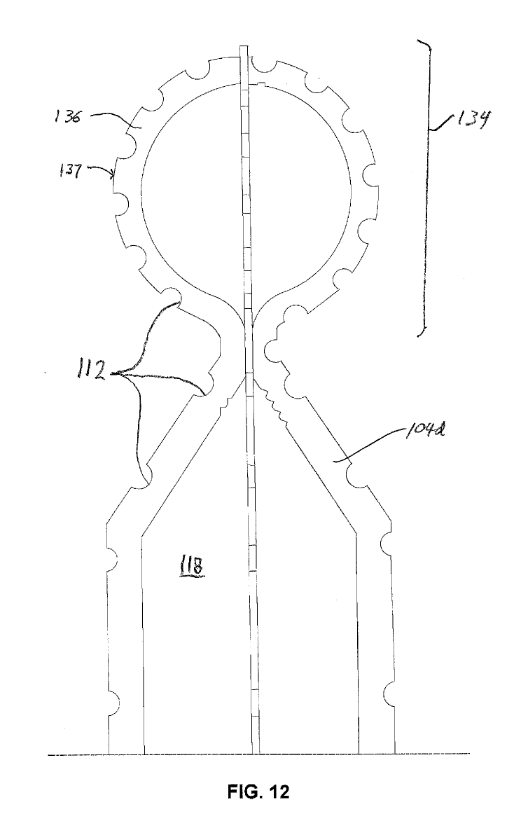

In one embodiment, the head portion 134 is characterized as outlining a three-dimensional object forming a sphere, as exemplified in FIG. 12. In another embodiment, the head portion 134 is characterized as outlining a three-dimensional object forming a three-dimensional flame, as exemplified in FIGS. 13-14.

Through embodiments of the invention, the elongated flexible light emitting members 116, 117 may be configured, for example, to represent an easily recognized sports organization, or a holiday object such as, for example, a candy-cane.

Through embodiments of the invention, the head portion arm members 136 may be configured to represent an easily recognized object or figure such as, for example, a flame, a football, or a basketball; and the elongated flexible illuminated members (e.g., 116, 117) may be configured to represent as easily recognizable sports organization bearing the colors of a professional, collegiate or other sports team. The elongated support arms may also be easily configured to represent an easily recognized holiday figure such as, for example, Santa Claus, the Easter Bunny or a snow man, by, for instance, bowing laterally outwardly, in a manner similar to the head portion 134 illustrated in FIG. 12.

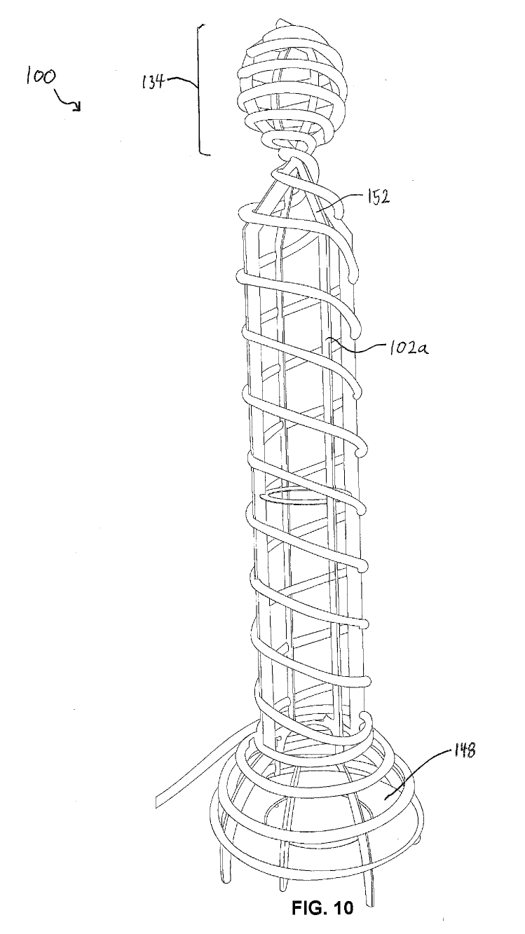

In yet another preferred embodiment, a helical light display 100 is provided comprising a rigid rod frame 152 having an ornamental configuration, and the frame defines a plurality of notches 112 disposed along an outer surface of the rod frame 152. In such embodiment, the notches 112 are preferably adapted to receive and support an elongated flexible light emitting tubular member 116, 117 wherein the notches 112 are configured to orient a plurality of flexible light emitting tubular members (e.g., 116, 117) in at least a double helix orientation, as illustrated in FIGS. 8-11.

The rigid rod frame 152 is configured for either an unattended freestanding balanced position free-standing atop the surface of the ground 150 or a securely anchored position into the surface of the ground 150.

The helical light display 100 preferably comprises a first elongated flexible light emitting tubular member 116 helically disposed around the rigid rod frame 152 as supported by and fitted within the notches 112, and a second elongated flexible light emitting tubular member 117 helically disposed around the rigid rod frame 152 in between the first helically disposed elongated light emitting member 116.

The helical light display 100 preferably comprises a single electrical supply wire splitting and transitioning to a first elongated flexible light emitting tubular member 116 having a first color helically disposed around said rigid rod frame 152 as supported by and fitted within the notches 112, and a second elongated flexible light emitting tubular member 117 having a second color helically disposed around the rigid rod frame 152 in between the first helically disposed elongated light emitting member 116.

In a preferred embodiment, the helical light display comprises a plurality of elongated flexible light emitting tubular members helically disposed around the rigid rod frame as fitted within and supported by the notches 112 forming a double helix orientation of the tubular members 116, 117, as exemplified in FIGS. 8-11.

In yet another preferred embodiment, the helical light display comprises a plurality of elongated flexible light emitting tubular members (e.g., 116, 117) helically disposed around the rigid rod frame 152 as fitted within and supported by the notches 112 forming a triple helix orientation of the tubular members.

The preferred lighted structure includes three or more elongated support legs wherein each leg defines a plurality of substantially semi-circular notches 112 disposed therethrough along the outer edge. The substantially semi-circular notches 112 are preferably spaced substantially equilaterally from one another along the outer edges of the support legs to form a substantially helical pattern, as illustrated for example, in FIG. 11. As used herein, the term “semi-circular” refers to notches 112 having oval, circular, and other smooth arcuate cross sections, which are further illustrated in the close-up views of the preferred embodiments shown in FIGS. 12, 13, and 15. The term “substantially equilaterally” refers to the fact the distance between the centers of the substantially circular notches 112 is substantially the same, with minor variations due to the effect of the preferred helix angles, manufacturing defects and other variations which do not substantially inhibit receiving and supporting the rope light.

Because the elongated flexible members are preferably colored and translucent, in the daytime when lightbulbs may not conventionally be as effective as nighttime, details of the character, orientation, and color combination can nevertheless still be discerned through embodiment of the invention because of the structurally unobstructed character and resulting visual effect and illuminating effect of the light emitting tubular member being disposed around the outer periphery (i.e., 360 degrees) of the device 100 and through the cavities of the device 100, (i.e., unobstructed by support members), as exemplified in FIGS. 3, 6, 8, and 11. That is, ambient light can shine through the translucent flexible members to make them readily visible, with the transmitted light being of the intended color. Because the elongated flexible members are disposed around the outer perimeter of the support feet 132, elongated support legs 102, and head 134 of the device 100, the device 100 does not interfere with the transmitted image, but rather help emphasize the outlines and orientation of the elongated flexible members 102 and intended decoration.

Preferably, each elongated flexible member 116, 117 is formed of such a material and thickness so as to accentuate the light emanating from the lightbulbs therein at nighttime and other low-light conditions. Preferably, the material and thickness can be selected to reflect, refract or otherwise diffuse the light emanating from the lightbulbs of the elongated flexible member 116, 117 surrounding the device 100. Many common plastics can achieve this effect.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A three-dimensional lighted object display device comprising:
at least three elongated support legs, each support leg having an upper portion opposite a lower portion and oriented relative to each other to have an outer surface radially disposed opposite an inner surface, the outer surface of each said support leg defining a plurality of tubular member support notches, said plurality of notches spaced longitudinally along said outer surface and adapted to receive and secure against movement relative to said leg a portion of an elongated flexible light emitting tubular member, said elongated support legs forming a visually unobstructed three-dimensional cavity between said legs; and
a base assembly rigidly connected to the lower portion of at least two of said support legs.

2. The three-dimensional lighted object display device of claim 1, the device having four elongated support legs, wherein the base assembly is characterized as bell-shaped comprising at least four arcuate base leg members, each base leg member having an outer surface defining a plurality of tubular member support notches adapted to receive and secure against movement relative to said base leg a portion of an elongated flexible light emitting tubular member.

3. The three-dimensional lighted object display device of claim 1, further comprising an elongated flexible light emitting tubular member, wherein the elongated flexible light emitting tubular member is spirally mounted to the support legs as securely engaged with the notches.

4. The three-dimensional lighted object display device of claim 1, further comprising a first elongated flexible light emitting tubular member and a second flexible light emitting tubular member, wherein the first and second tubular members encircle the support legs as securely engaged with the notches to provide unobstructed illumination around the device.

5. The three-dimensional lighted object display device of claim 1, wherein the notches are characterized as having a size smaller than a diameter of the flexible light emitting tubular member to be received and supported without fasteners whereby an illumination from said tubular member remains unobstructed when said tubular member is received and supported by said notches of the support legs.

6. The three-dimensional lighted object display device of claim 1, wherein the notches along the outer surfaces of said support legs are pre-configured for receipt of respective portions of the elongated flexible light emitting tubular member to provide a visual display of illumination correlating to said pre-configuration.

7. The three-dimensional lighted object display device of claim 1, further comprising a three-dimensional head assembly comprising at least three head support members peripherally spaced around a central axis of said head assembly providing a head cavity therebetween, each head support member having an outer surface defining a plurality of notches adapted to receive and support an elongated flexible light emitting tubular member, said head assembly outlining a character or an object.

8. The three-dimensional lighted object display device of claim 1, wherein said plurality of notches provide a radial separation between elongated flexible light emitting tubular members encircling the elongated support legs upon receipt of said tubular members in said notches, said radial separation forming an open light cavity within said encircling tubular members for three-dimensional illuminated display.

9. The three-dimensional lighted object device of claim 1, wherein the plurality of notches are disposed in a repetitive helical pattern relative to the elongated support legs.

10. The three-dimensional lighted object device of claim 1, wherein said device is of unitary construction forged from a material selected from a group consisting of plastic, resin, high-density polyethylene, rubber, and steel.

11. A lighted device comprising:
a vertical support structure comprising at least three vertical support leg members, wherein each vertical support leg member is peripherally spaced around a central vertical axis of the structure forming an open leg cavity therebetween, each vertical support leg having an outer surface defining a plurality of axially spaced notches adapted to receive and support an elongated flexible light emitting tubular member;
each vertical support leg member having an upper section transitioning to a connection point with the other vertical support leg members and having a lower section transitioning to a base portion of the device configured to balance the vertical support structure in a substantially upright free-standing position;
a head portion disposed atop the connection point, said head portion comprising at least three head support members peripherally spaced around a central axis of said head portion providing a head cavity therebetween, each head support member having an outer surface defining a plurality of support notches adapted to receive and support an elongated flexible light emitting tubular member against axial movement relative to the support member at each notch; and
at least a first elongated flexible light emitting tubular member disposed around said vertical support structure and said head portion as supported by and fitted within said notches to provide structurally unobstructed illuminating effect by said light emitting tubular member around the outer periphery of said device and through said cavities of said device.

12. The lighted device of claim 11, further comprising a second elongated flexible light emitting tubular member disposed around said vertical support structure and said head portion as supported by and fitted within said notches, wherein said notches are configured to orient a plurality of flexible light emitting tubular members in at least a double helix orientation, to provide double helix illuminating effect along the outer periphery of and through said cavities of said device.

13. The lighted device of claim 11, wherein said head portion is characterized as outlining a three-dimensional object forming a sphere.

14. The lighted device of claim 11, wherein said head portion is characterized as outlining a three-dimensional object forming a flame.

15. A helical light display comprising:
a rigid rod frame having an ornamental configuration, said frame defining a plurality of notches disposed along an outer surface of said rod frame and adapted to receive and support an elongated flexible light emitting tubular member, wherein said notches are configured to orient a plurality of flexible light emitting tubular members in at least a double helix orientation.

16. The helical light display of claim 15, further comprising a first elongated flexible light emitting tubular member helically disposed around said rigid rod frame as supported by and fitted within said notches, and a second elongated flexible light emitting tubular member helically disposed around said rigid rod frame in between the first helically disposed elongated light emitting member.

17. The helical light display of claim 15, further comprising a first elongated flexible light emitting tubular member having a first color helically disposed around said rigid rod frame as supported by and fitted within said notches, and a second elongated flexible light emitting tubular member having a second color helically disposed around said rigid rod frame in between the first helically disposed elongated light emitting member.

18. The helical light display of claim 15, further comprising a plurality of elongated flexible light emitting tubular members helically disposed around said rigid rod frame as fitted within and supported by said notches forming a double helix orientation and illumination of said tubular members.

19. The helical light display of claim 15, further comprising a plurality of elongated flexible light emitting tubular members helically disposed around said rigid rod frame as fitted within and supported by said notches forming a triple helix orientation of said tubular members.
